(19) United States
(12) Patent Application Publication
(10) Pub. No.: US 2016/0236775 A1
(43) Pub. Date: Aug. 18, 2016

(54) VERTICAL TAKEOFF AND LANDING AIRCRAFT

(71) Applicant: Siniger LLC, Long Beach, CA (US)

(72) Inventors: Maxim ESHKENAZY, Long Beach, CA (US); Eric Richard BARTSCH, Champaign, IL (US)

(21) Appl. No.: 15/046,796

(22) Filed: Feb. 18, 2016

Related U.S. Application Data
(60) Provisional application No. 62/176,320, filed on Feb. 18, 2015.

(51) Int. Cl. B64C 29/00; B64D 27/24

(52) U.S. Cl. CPC B64C 29/0025; B64D 27/24

(57) ABSTRACT

A vertical takeoff and landing aircraft includes an airframe with a wing having an airfoil, the airfoil having an airfoil chord line and the wing having a wingspan. The aircraft further includes at least one forward thrust rotor having a horizontal thrust offset angle defined between the airfoil chord line and an axis of rotation of the forward thrust rotor. The aircraft further includes a plurality of vertical thrust rotors, each of the plurality of vertical thrust rotors having a vertical thrust offset angle defined between the airfoil chord line and a plane of rotation of the vertical thrust rotor. The vertical thrust offset angle is between 3 degrees and 10 degrees. The axis of rotation of the forward thrust rotor and planes of rotation of the plurality of vertical thrust rotors define a plurality of relative thrust angles that are each less than the horizontal thrust offset angle.

### CROSS-REFERENCE TO RELATED PATENT APPLICATION

This application claims priority to U.S. Provisional Patent Application No. 62/176,320, filed on Feb. 18, 2015, the entirety of which is incorporated herein by reference.

### FIELD

The present technology is generally related to vertical takeoff aircraft.

### BACKGROUND

Aircraft are widely used in a variety of applications including, for example, military, commercial, civil, experimental, entertainment, drones, and other general aviation applications. Conventional aircraft typically use a long runway to accelerate on the ground until the aircraft wings have attained sufficient lift to takeoff. Similarly, on landing, these aircraft use the runway to decelerate until the aircraft may be safely brought to a halt. In recent times, to avoid the need for large and costly runway infrastructure, vertical takeoff and landing (“VTOL”) aircraft have gained popularity. Aircraft that take off and land vertically, instead of using the runway, use both vertical and horizontal thrust. Thrust produced in the vertical direction provides lift to the aircraft during takeoff and landing, while thrust produced in the horizontal direction provides forward movement during flight.

### SUMMARY

An illustrative vertical takeoff and landing aircraft includes an airframe with a wing having an airfoil, the airfoil having an airfoil chord line and the wing having a wingspan. The aircraft further includes at least one forward thrust rotor having a horizontal thrust offset angle defined between the airfoil chord line and an axis of rotation of the forward thrust rotor. The aircraft further includes a plurality of vertical thrust rotors, each of the plurality of vertical thrust rotors having a vertical thrust offset angle defined between the airfoil chord line and a plane of rotation of the vertical thrust rotor. The vertical thrust offset angle is between 3 degrees and 10 degrees. The axis of rotation of the forward thrust rotor and planes of rotation of the plurality of vertical thrust rotors define a plurality of relative thrust angles that are each less than the horizontal thrust offset angle, and axes of rotation of the plurality of vertical thrust rotors are spaced apart at distances between 25% and 75% of the wingspan.

An illustrative vertical takeoff and landing aircraft includes an airframe with a wing having an airfoil, the airfoil having an airfoil chord line and the wing having a wingspan. The aircraft further includes at least one forward thrust rotor having a horizontal thrust offset angle defined between the airfoil chord line and an axis of rotation of the forward thrust rotor. The at least one forward thrust rotor further has a forward rotor pitch angle defined between a plane of rotation of the forward thrust rotor and a forward thrust rotor blade chord line at a point midway between the axis of rotation of the forward thrust rotor and a tip of a forward thrust rotor blade. The aircraft further includes a plurality of vertical thrust rotors, each of the plurality of vertical thrust rotors having a vertical thrust offset angle defined between the airfoil chord line and a plane of rotation of the vertical thrust rotor. The vertical thrust offset angle is between 3 degrees and 10 degrees. Each of the plurality of vertical thrust rotors further has a vertical rotor pitch angle defined between the plane of rotation of the vertical thrust rotor and a vertical thrust rotor chord line at a point midway between an axis of rotation of the vertical thrust rotor and a tip of a vertical thrust rotor blade. The vertical rotor pitch angle is less than the forward rotor pitch angle and the plurality of vertical thrust rotors have fixed pitch rotors such that the vertical rotor pitch angle is not adjustable during flight. The axis of rotation of the forward thrust rotor and planes of rotation of the plurality of vertical thrust rotors define a plurality of relative thrust angles that are each less than the horizontal thrust offset angle. Axes of rotation of the plurality of vertical thrust rotors are spaced apart at distances between 25% and 75% of the wingspan.

### BRIEF DESCRIPTION OF THE DRAWINGS

Illustrative embodiments will hereafter be described with reference to the accompanying drawings.

FIG. 1 is an illustrative diagram of an isometric view of a vertical takeoff and landing aircraft, in accordance with at least some embodiments.

FIG. 2 is an illustrative diagram of a side view of a vertical takeoff and landing aircraft, in accordance with at least some embodiments.

FIG. 3 is an illustrative diagram of a forward thrust rotor of a vertical takeoff and landing aircraft, in accordance with at least some embodiments.

FIG. 4 is an illustrative diagram of a vertical thrust rotor of a vertical takeoff and landing aircraft, in accordance with at least some embodiments.

FIG. 5 is an illustrative diagram of a top view of a vertical takeoff and landing aircraft, in accordance with at least some embodiments.

FIG. 6 is an illustrative diagram of an isometric view of an alternate vertical takeoff and landing aircraft, in accordance with at least some embodiments.

FIG. 7 is an illustrative diagram of an isometric view of a second alternate vertical takeoff and landing aircraft, in accordance with at least some embodiments.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Described herein are illustrative embodiments for a controllable and efficient vertical takeoff and landing aircraft that can controllably transition between horizontal and vertical flight through independent vertical and horizontal thrust systems with multiple electric vertical thrust motors that operate independently of at least one forward thrust propulsion system. The vertical thrust motors, forward propulsion system, wing, and center of gravity of the aircraft make the aircraft stable and efficient in both vertical flight and horizontal flight. The embodiments disclosed herein are sufficiently stable and allow a pilot of the aircraft to easily control the transitions between hovering flight and forward flight, and back to hovering flight, without mechanically complex and unreliable systems for repositioning or rotating the rotors or powerplants.

The vertical takeoff and landing aircraft disclosed herein can take off vertically, transition safely to forward flight, cruise efficiently, transition back to vertical flight, and land vertically. The configuration of the wings, airframe, vertical thrust rotors, and horizontal thrust motor; allows for safe operation of the aircraft in all phases of flight. The vertical takeoff aircraft is also configured to be significantly more efficient for long distance flight than conventional vertical takeoff aircraft such as helicopters, while also being less mechanically complex than vertical takeoff aircraft such as tilt-rotor aircraft.

Advantageously, the aircraft disclosed herein can take off and land vertically to avoid the need for large and costly runway infrastructure to be available at every location where it is intended for the aircraft to take off and land. Further, such vertical takeoff and landing (VTOL) aircraft can fly quickly and efficiently when operating in horizontal flight. An aircraft that takes off and lands vertically, instead of using a runway to develop sufficient velocity on the ground for wings to provide adequate lift, provides both vertical and forward thrust. Thrust produced in the vertical direction provides lift to the vehicle when the forward airspeed is below a level that generates life with the wing; thrust produced horizontally provides forward movement. A vertical takeoff and landing (VTOL) aircraft as disclosed herein can produce both vertical and horizontal thrust, and can transition from vertical flight at takeoff, to horizontal for cruise, and back to vertical for landing. Advantageously, the VTOL aircraft disclosed herein can safely and easily transition between horizontal and vertical flight modes. The embodiments disclosed herein also provide for good transitions for remotely controlled VTOL aircraft, despite a pilot not having the benefit of sensing the movement of the aircraft, and the pilot may have little or no instrumentation provided for airspeed, attitude, and vertical speed. The embodiments disclosed herein configure the points of thrust and the balance of an aircraft to increase stability without sacrificing maneuverability.

In an illustrative embodiment, the VTOL aircraft includes an airframe with a fuselage, wing, aerodynamic control surfaces that control the aircraft in three axes (pitch, yaw, roll) during forward flight, a forward thrust motor and rotor, and four vertical thrust motors and rotors. In other embodiments, the aircraft may use six vertical thrust rotors or may use any even number or other amount of vertical thrust rotors. The vertical thrust rotors are positioned at a fixed angle with respect to the fuselage and wing, and are tilted forward between three (3) and ten (10) degrees with respect to the chord line of the wing to produce a small amount of forward thrust while producing a significantly larger amount of vertical thrust. The angle may be anywhere between 3-10 degrees. For example, the angle may be 3, 3.5, 4, 4.5, 5, 5.5, 6, 6.5, 7, 7.5, 8, 8.5, 9, 9.5, or 10 degrees. This angular alignment creates stability while also easing the transition between vertical and forward flight. The pilot or autopilot has independent control of both the vertical thrust system and the horizontal (or also referred to herein as forward) thrust system, offering added control through the transition points in the flight. Maintaining separate sets of vertical thrust rotors and horizontal thrust rotors as disclosed herein allows instant independent variation of thrust in both axes, which may not be possible if both vertical and horizontal thrust are delivered by a single set of rotors that are repositioned during the transition phases of flight. Pitch, roll, and yaw of a VTOL aircraft may be controlled by one or more of aerodynamic surfaces (e.g., ailerons), forward thrust rotor(s), and/or vertical thrust rotors(s). For example, ailerons on a wing roll, elevators on a tail may be used to control pitch, and a rudder on a tail may be used to control pitch. Alternative configurations may also be used such as ailerons on a flying wing configured aircraft, which control both pitch and roll depending on their deflection. Additional alternative embodiments include a V-tail configuration where the rudder and elevator functions are combined on the same set of control surfaces to control both pitch and yaw. Vertical thrust rotors and forward thrust rotors may also be used together or combination to affect pitch, roll, and yaw depending on the rotation of the rotors, the offset angles at which the rotors are placed (i.e., the planes in which the rotors rotate), the magnitude at which various rotors are exerting thrust, etc.

Mounting each of the vertical thrust rotors and forward thrust rotors on fixed positions on the aircraft also creates a mechanically simpler and more reliable aircraft design than a tilt-rotor vertical takeoff aircraft. Additionally, the separation of the forward thrust and vertical thrust systems allows for the use of fixed pitch rotor blades for the vertical thrust system, allowing a much simpler and lighter weight rotor system that is more reliable and robust than either a variable pitch rotor on a tilt-rotor or a helicopter rotor with both cyclic and collective pitch mechanisms.

The use of electric motors to directly drive the vertical thrust rotors can make an aircraft light and have reliable transmissions, and allow for extremely rapid adjustment of torque and power to each vertical thrust rotor independently to enable precise control of the aircraft. Electric motors offer good latency in VTOL aircraft. If desirable, the electric motors driving the vertical thrust motors can be powered by batteries, onboard generators, or a combination of both. However, in alternative embodiments, other types of engines or motors such as turbine or piston engines may still be used in the embodiments disclosed herein. In one embodiment, the forward and vertical thrust motors may all be electric. In another embodiment, the forward thrust motor may be a piston or turbine engine that powers the forward thrust rotor and an electric generator. The electric generator powers vertical thrust motors that rotate the vertical thrust rotors. In another embodiment, the forward thrust motor may be a jet engine or ducted fan, where the rotors moving air and providing thrust are contained within the housing of the motor or airframe.

Positioning of the vertical thrust rotors assists in balancing stability, controllability, and structural efficiency. In one embodiment, four vertical thrust rotors are positioned on the aircraft such that their axes of rotation are separated by no more than 75% of the wingspan and no less than 25% of the wingspan. A separation of less than 25% results in the wing having a high moment of inertia while the rotors have a very short moment arm to stabilize the aircraft. The result of having a wing that is too long and rotors that are too closely spaced is a minimally controllable or uncontrollable aircraft. A separation of more than 75% of the wingspan results in a high structural weight to transfer the load from rotors that are delivering high thrust at positions far from the center of gravity of the aircraft. The spacing of various vertical thrust rotors may be anywhere between 25%-75% of the wingspan of the aircraft. For example, spacing between vertical thrust rotors may be 25%, 30%, 35%, 40%, 45%, 50%, 55%, 60%, 65%, 70%, or 75% of the wingspan of the aircraft. In some embodiments, only some of a plurality of vertical thrust rotors may be separated by a distance of 25%-75% of the wingspan of the aircraft, while others of the plurality of vertical thrust rotors may be spaced at distances outside that range.

In an illustrative embodiment, the center of lift of all vertical thrust rotors of a VTOL aircraft, when operating at identical thrust levels, is aft (nearer to the rear) of the center of gravity of the aircraft and ahead (nearer to the front) of the center of lift of the wing. This ensures that the piloting characteristics of the aircraft remain conventional through all elements of the transition of the flight. The acceptable loading range of the aircraft is managed to ensure that both the forward and aft limits of the center of gravity remain forward of the center of lift of the vertical thrust rotors.

In other embodiments, additional vertical thrust rotors may be added to achieve increased redundancy beyond four rotors. In such alternate embodiments, the added rotors may be positioned closer together than the initial four, but may be grouped such that there are clusters of rotors that still obey the rule of being farther than 25% of the wingspan from each other, and also closer than 75% of the wingspan. In other embodiments, some of the vertical thrust rotors may exist outside the 25%-75% range of the length of the wingspan.

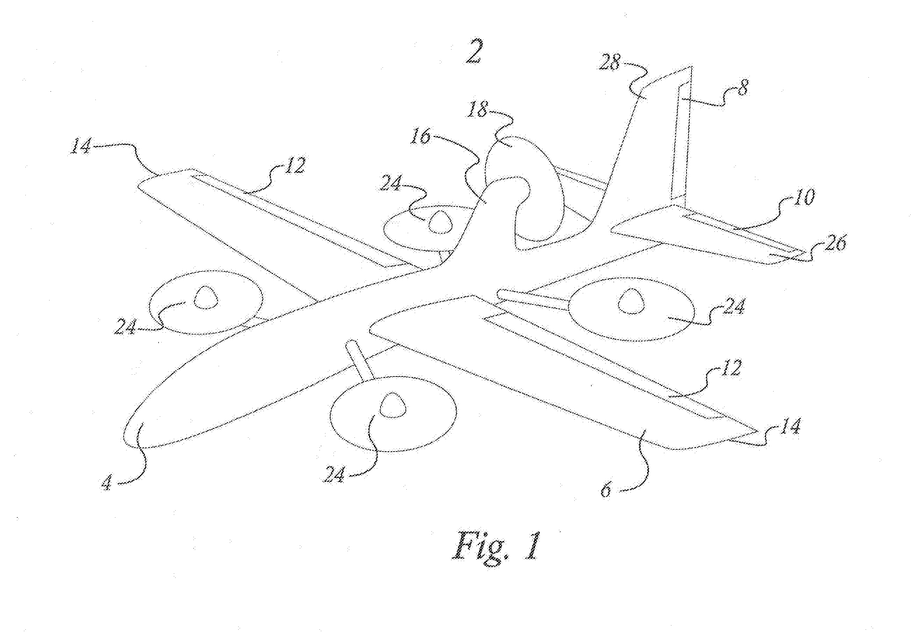

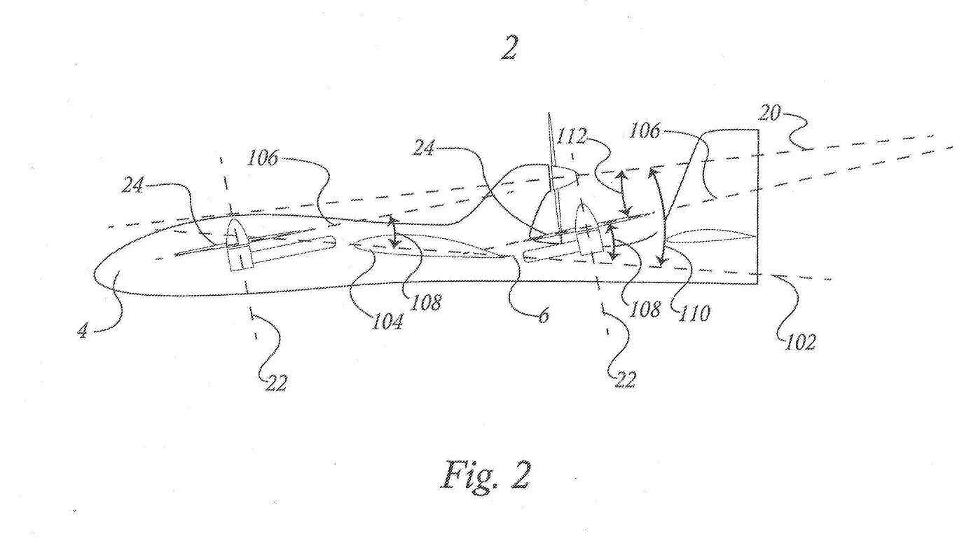

FIG. 1 is an illustrative diagram of an isometric view of a vertical takeoff and landing aircraft 2 in accordance with at least some embodiments. FIG. 2 is an illustrative diagram of a side view of a vertical takeoff and landing aircraft 2 in accordance with at least some embodiments. The aircraft 2 may be any type of aircraft in which it is desirable to have at least some vertical motion, whether during takeoff, landing, or during flight, coupled with at least some horizontal/forward motion. Furthermore, the aircraft 2 may be of any size or weight. For example, in at least some embodiments, the aircraft 2 may be a small aircraft having a total weight of less than five kilograms, a total length of less than half a meter, and a wingspan of less than half a meter. In other embodiments, the aircraft 2 may be a larger/heavier aircraft, capable of carrying passengers and cargo, or smaller/lighter than that described above. Additionally, the aircraft 2 may be a manned aircraft configured to carry one or more pilots on board, or alternatively, the aircraft may be an unmanned aircraft or drone configured to navigate either as a remotely piloted vehicle or autonomously under remote or programmed direction.

The aircraft 2 includes an airframe that includes a wing 6 and a fuselage 4. The aircraft also includes vertical thrust rotors 24 and a forward thrust rotor 18. A combined maximum thrust of the plurality of vertical thrust rotors 24 may be, for example, greater than 120% of a maximum takeoff weight of the vertical takeoff and landing aircraft 2. Other amounts of thrust may also be used in different embodiments. The forward thrust rotor 18 is turned by a forward thrust motor 16. The wing 6 includes an airfoil that has a chord line 102. The aircraft 2 also includes conventional aerodynamic control surfaces including: yaw control surface 8, pitch control surface 10, and roll control surfaces 12. The surfaces may control other various characteristics of the aircraft 2 as well (e.g., roll control surfaces 12 may also control pitch, etc.). The wing 6 has a wingspan defined by the distance between the two wingtips 14. Each vertical thrust rotor 24 has an axis of vertical thrust 22 about which said vertical thrust rotor 24 rotates. The aircraft 2 also includes a horizontal stabilizer 26 and a vertical stabilizer 28.

In the illustrative embodiment, the aircraft 2 has four vertical thrust rotors 24 positioned such that the distance between each of the four axes of vertical thrust 22 are no less than 25% of said wingspan and no greater than 75% of said wingspan. In other words, axes of rotation of the vertical thrust rotors 24 are spaced apart at distances between 25% and 75% of the wingspan of the aircraft/wing. In this illustrative embodiment, the four vertical thrust rotors 24 are driven by electric motors which are ideal for independently making rapid adjustments to the torque and thrust delivered by each vertical thrust rotor 24 to control the pitch, yaw, roll, and vertical climb rate of the aircraft 2 during low-speed or hovering flight regimes.

A chord line 102 can be defined by the aerodynamic center of airfoil 104 of the wing 6. Planes of rotation 106 for each vertical thrust rotor 24 can be defined by the plane perpendicular to axes of vertical thrust 22 through which vertical thrust rotor blades 302 pass when in motion. A vertical thrust offset angle 108 is defined as the angle between a plane of rotation 106 of the vertical thrust rotor 24 and the chord line 102 of the airfoil of the wing. The vertical thrust offset angle 108 is greater than three degrees to enable a steady transition between vertical flight and forward flight, and the vertical thrust angle 108 is less than ten degrees to enable hovering flight, takeoff, and landing; without having an excessive nose up attitude of aircraft 2.

An axis of forward thrust 20 is defined by the rotational axis of forward thrust rotor 18. A horizontal thrust offset angle 110 is defined by the angle between the axis of forward thrust 20 and the chord line 102. In other words, the forward thrust rotor 18 has a horizontal thrust offset angle 110 defined between the airfoil chord line 102 and an axis of rotation of the forward thrust rotor 20. A plurality of relative thrust angles 112 are defined by the angle between each of the planes of rotation 106 and the axis of forward thrust 20. Each of the relative thrust angles 112 is less than the horizontal thrust offset angle 110 to ensure controllability of the aircraft 2 in hovering flight, during the transition from hover to forward flight, and during the transition from forward flight to hover. In other words, the axis of rotation 20 of the forward thrust rotor 18 and planes of rotation 106 of the plurality of vertical thrust rotors 24 define a plurality of relative thrust angles 112 that are each less than the horizontal thrust offset angle 110.

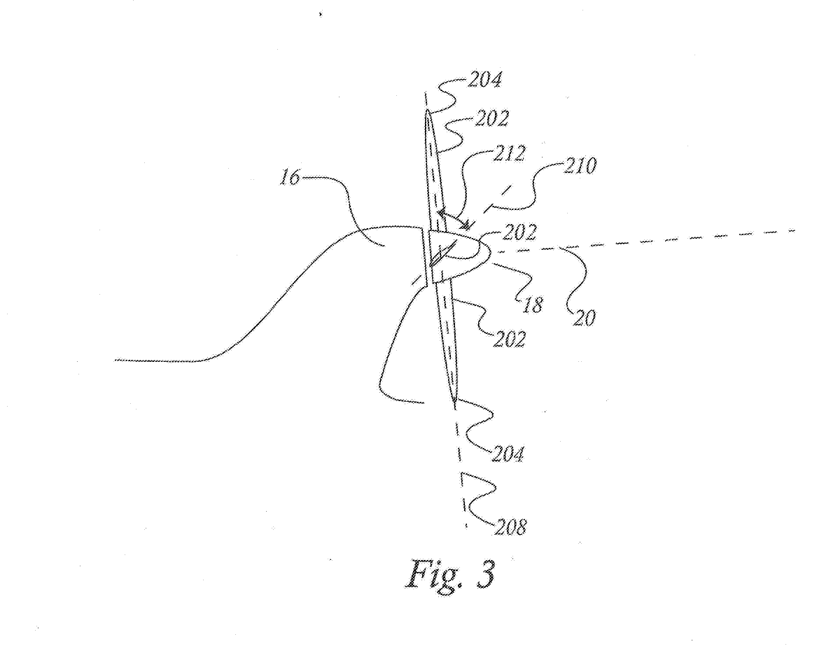

FIG. 3 is an illustrative diagram of a forward thrust rotor of a vertical takeoff and landing aircraft in accordance with at least some embodiments. The forward thrust rotor 18 includes multiple forward thrust rotor blades 202 which rotate around the axis of forward thrust 20 within a plane of rotation of forward thrust rotor 208. Each forward thrust rotor blade 202 has a forward thrust rotor blade tip 204 and a forward thrust rotor blade chord line 210 defined by the chord of the forward thrust rotor blade 202 at the midpoint between the axis of forward thrust 20 and the forward thrust rotor blade tip 204. A forward thrust rotor blade pitch angle 212 is defined as the angle between the forward thrust rotor blade chord line 210 and the plane of rotation of forward thrust rotor 208. The forward thrust rotor blade pitch angle 212 of FIG. 3 refers to the acute angle between the forward thrust rotor blade chord line 210 and the plane of rotation of forward thrust rotor 208. In other words, the forward thrust rotor further 18 has a forward rotor pitch angle 212 defined between the plane of rotation of the forward thrust rotor 208 and the forward thrust rotor blade chord line 210 at a point midway between the axis of rotation 20 of the forward thrust rotor 18 and the tip 204 of a forward thrust rotor blade 202.

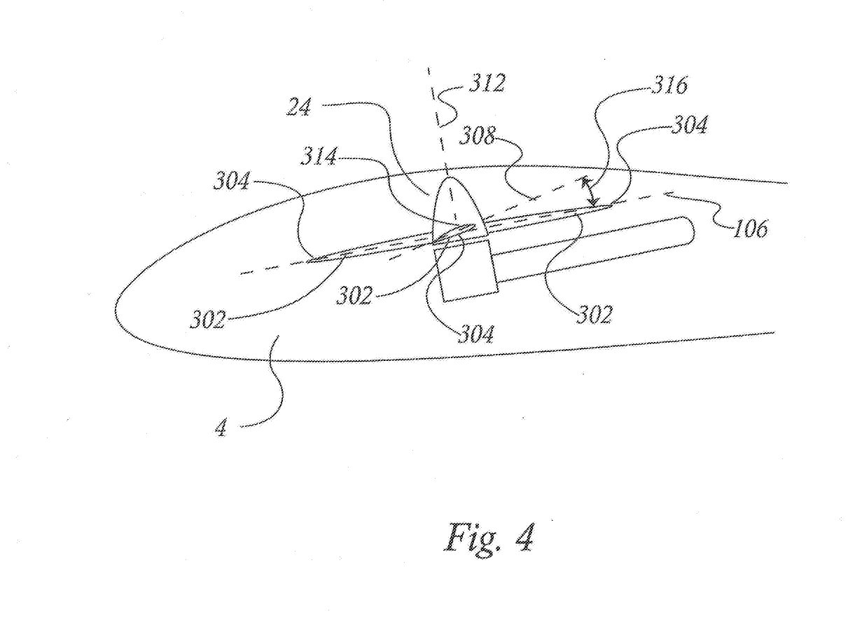

FIG. 4 is an illustrative diagram of a vertical thrust rotor of a vertical takeoff and landing aircraft in accordance with at least some embodiments. Each vertical thrust rotor 24 includes multiple vertical thrust rotor blades 302 which rotate around axes of vertical thrust 312 (shown as axes 22 in FIG. 2) within the planes of rotation 106. Each vertical thrust rotor blade 302 has a vertical rotor blade tip 304 and a vertical rotor blade chord line 308 defined by the chord of the vertical thrust rotor blade 302 at the midpoint between its axis of vertical thrust 312 and its vertical rotor blade tip 304. A vertical thrust rotor blade pitch angle 316 is defined as the angle between the plane of rotation 106 and the vertical thrust rotor blade chord line 308. The vertical thrust rotor blade pitch angle 316 of FIG. 3 refers to the acute angle between the plane of rotation 106 and the vertical thrust rotor blade chord line 308. In other words, the vertical thrust rotors have a vertical rotor pitch angle 316 defined between the plane of rotation 106 of the vertical thrust rotor 24 and a vertical thrust rotor chord line 308 at a point midway between an axis of rotation 312 of the vertical thrust rotor 24 and the tip 304 of a vertical thrust rotor blade 302.

In order to enhance stability and efficiency, and due to the fact that the rotors on this vertical takeoff and landing aircraft 2 are not repositioned to provide primary vertical and horizontal thrust from the same set of rotors, the vertical thrust rotors 24 and the forward thrust rotor 18 have rotor blades optimized for their unique operating environments. The vertical thrust rotor blade pitch angle 316 for each of the vertical thrust rotor blades 302 included on each of the vertical thrust rotor 18 is less than the forward thrust rotor blade pitch angle 212 of each of the forward thrust rotor blade 202 included on the forward thrust rotor 18. The chord length of vertical thrust rotor blades 302 is also larger than that of the forward thrust rotor blades 202; and the thickness of the vertical thrust rotor blades 302 measured perpendicular to their blade chord lines are less than the thickness of the forward thrust rotor blades 202 when measured perpendicular to their blade chord lines. Other relative sizes of the various rotors, rotor blades, and chord lengths may be used in different embodiments.

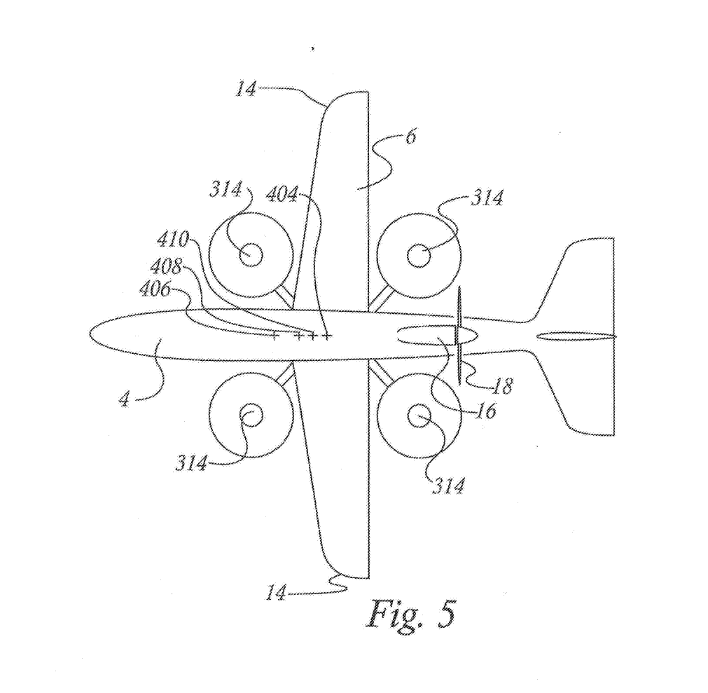

FIG. 5 is an illustrative diagram of a top view of a vertical takeoff and landing aircraft 2 in accordance with at least some embodiments. The aircraft 2 includes a center of thrust 410, a center of wing lift 404 and a center of gravity that must be positioned forward (nearer to the front of the aircraft) of both the center of thrust 410 and the center of wing lift 404. A range of acceptable center of gravity positions is shown in FIG. 5. Limit of forward center of gravity 406 shows a forward-most position for the center of gravity for controllable and efficient operation of the aircraft 2. Limit of aft center of gravity 408 represents a farthest aft position for controllable and efficient operation of the aircraft 2. The center of thrust 410 is an effective position of the thrust of all vertical thrust rotors 24 when they are operating at identical power levels. In other words, the center of thrust 410 is located where combined thrust of all vertical thrust rotors is acting when the vertical thrust rotors are delivering substantially identical amounts of thrust. The center of thrust 410 is positioned aft of the limit of aft center of gravity and forward of the center of wing lift 404. In other words, the center of gravity is positioned nearer to a front of the vertical takeoff and landing aircraft than the center of lift of the wing and the center of thrust; and the center of thrust is nearer to the front of the vertical takeoff and landing aircraft than the center of lift.

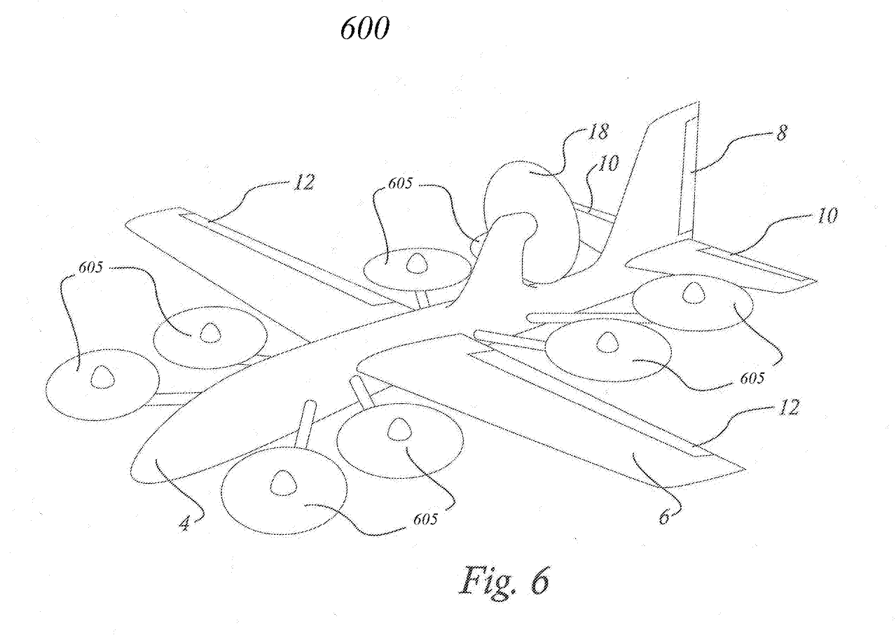

FIG. 6 is an illustrative diagram of an isometric view of an alternate vertical takeoff and landing aircraft 600 in accordance with at least some embodiments. Many alternate embodiments of the vertical takeoff and landing aircraft detailed in this disclosure are possible. Additional alternate embodiments include aircraft 600 seen in FIG. 6. The aircraft 600 includes eight vertical takeoff rotors 605 coupled to eight independent vertical thrust electric motors. This configuration provides additional redundancy for manned flight applications in the event of the failure of a vertical takeoff rotor 605 or its associated vertical thrust motor. The angular alignment between the vertical takeoff rotors 605, the forward thrust rotor 18, and the chord line 102 of the wing 6 may be similar to those described in the embodiments above. At least four of the vertical takeoff rotors 24 are positioned with the distances between their axes of vertical thrust being no less than 25% of the wingspan of the wing 6 and no greater than 75% of the wingspan.

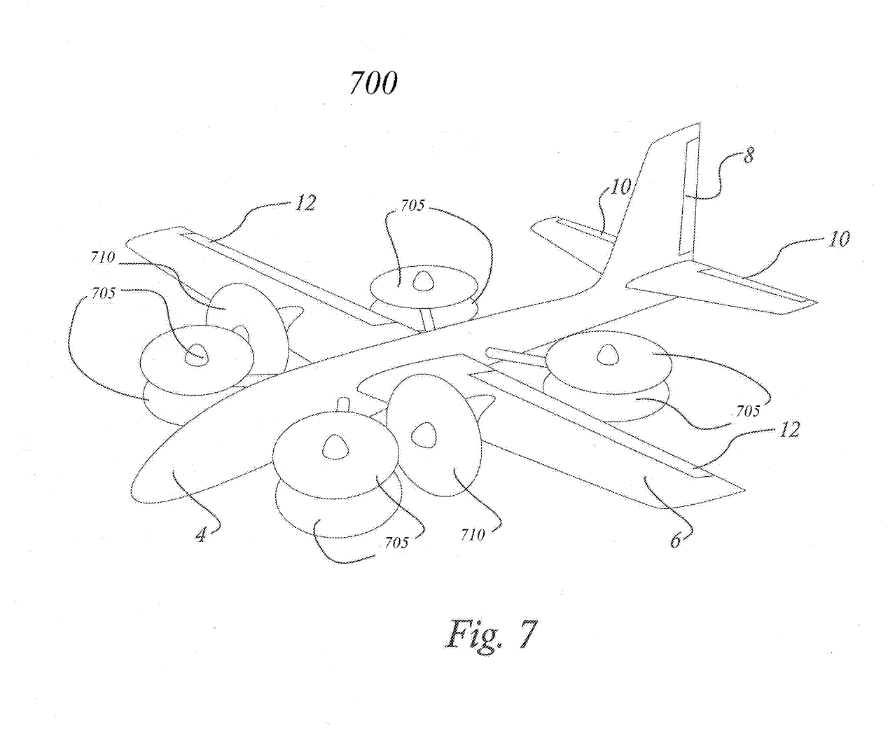

FIG. 7 is an illustrative diagram of an isometric view of a second alternate vertical takeoff and landing aircraft 700 in accordance with at least some embodiments. The aircraft 700 is designed with pairs of vertical takeoff rotors 705 with each pair of the vertical takeoff rotors 705 having their axes of vertical thrust substantially aligned with each other, and driven by two different electric motors coupled to each pair of the vertical takeoff rotors 705. The four pairs of the vertical takeoff rotors 705 have their axes of vertical thrust separated by a distance of no less than 25% of the wingspan of the wing 6 and no greater than 75% of the wingspan of the wing 6 for stability, structural weight, and controllability. Pairing the vertical takeoff rotors 705 and their accompanying motors provides redundancy in the case of a component failure for manned applications. Two forward thrust rotors 710 are included, with each of their respective horizontal thrust offset angles 110 with respect to the chord line 102 of the wing 6 being substantially the same. The angular alignment between vertical takeoff rotors 705, the pair of forward thrust rotors 710, and the chord line 102 of the wing 6 may be similar to those described in the embodiments above.

Additional alternate embodiments are contemplated that could utilize alternate aerodynamic control surface arrangements such as a V-tail or flying wing in place of the conventional horizontal stabilizer 26 and vertical stabilizer 28. Other alternate embodiments could include additional alternate configurations of vertical thrust rotors and forward thrust rotors that conform to different or similar positioning and angular alignment as disclosed herein.

For example, in an illustrative embodiment, the airframe or aircraft may not have a distinct fuselage or tail as shown in FIGS. 1, 2, and 5-7. Instead the airframe/aircraft may be a flying wing without a distinct fuselage and/or tail. Such an embodiment may still include aerodynamic surfaces that impact pitch/roll/yaw, at least one horizontal thrust rotor, a plurality of vertical thrust rotors, a wing with an airfoil, etc. as disclosed herein throughout. For example, a flying wing configuration using a wing similar to the wing 6 in FIG. 1 could be utilized with vertical thrust rotors 24 positioned ahead of and behind the wing 6, with the ailerons 12 utilized for both pitch and roll control depending on whether they are deflected in the same direction or opposing directions. A further illustrative embodiment would consist of a flying wing with a sufficiently large chord to permit some or all of the vertical thrust rotors to be embedded in holes passing substantially vertically through the wing 6 to enable air to flow past the vertical thrust rotors 24.

Notwithstanding the embodiments described above, various modifications, changes, and enhancements are contemplated and considered within the scope of the present disclosure. For example, the shape, size, and other configuration of the vertical thrust rotors and/or forward thrust rotor(s) may vary based upon the size and configuration of the aircraft. Similarly, the aircraft/airframe itself may vary in size, including the wing, fuselage, aerodynamic control surfaces, stabilizers, etc. Additionally, other components used for operation of a controller, receiver, pilot interfaces, vertical thrust system, forward thrust system, and aerodynamic system may be employed. In various embodiments, a computer algorithm may be developed to control the safe transition from vertical to forward flight modes and from forward to vertical flight modes by merely setting a position of a switch or button on the pilot interface, or a pilot may control the forward and vertical thrust systems. Additionally, any of such operations may be implemented as computer-readable instructions stored on a non-transitory computer-readable medium such as a computer memory. Other substitutions, modifications, changes, and omissions may be made in the design, operating conditions, and arrangement of the preferred and other illustrative embodiments without departing from scope of the present disclosure or from the scope of the appended claims

It is also to be understood that the construction and arrangement of the elements of the systems and methods as shown in the representative embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed.

Furthermore, functions and procedures described above may be performed by specialized equipment designed to perform the particular functions and procedures. The functions may also be performed by general-use equipment that executes commands related to the functions and procedures, or each function and procedure may be performed by a different piece of equipment with one piece of equipment serving as control or with a separate control device.

Moreover, although the figures show a specific order of method operations, the order of the operations may differ from what is depicted. Also, two or more operations may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection operations, processing operations, comparison operations, and decision operations.

While certain embodiments have been illustrated and described, it should be understood that changes and modifications can be made therein in accordance with ordinary skill in the art without departing from the technology in its broader aspects as defined in the following claims. All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure. Other embodiments are set forth in the claims.

In an illustrative embodiment, the components described herein can be controlled by operations embodied at least in part as computer-readable instructions stored on a computer-readable medium or memory. Upon execution of the computer-readable instructions by a processor, the computer-readable instructions can cause a computing device to perform the operations.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A vertical takeoff and landing aircraft, comprising:
an airframe comprising a wing having an airfoil, the airfoil having an airfoil chord line and the wing having a wingspan;
at least one forward thrust rotor having a horizontal thrust offset angle defined between the airfoil chord line and an axis of rotation of the forward thrust rotor; and
a plurality of vertical thrust rotors, each of the plurality of vertical thrust rotors having a vertical thrust offset angle defined between the airfoil chord line and a plane of rotation of the vertical thrust rotor, wherein the vertical thrust offset angle is between 3 degrees and 10 degrees,
wherein the axis of rotation of the forward thrust rotor and planes of rotation of the plurality of vertical thrust rotors define a plurality of relative thrust angles that are each less than the horizontal thrust offset angle, and axes of rotation of the plurality of vertical thrust rotors are spaced apart at distances between 25% and 75% of the wingspan.

2. The vertical takeoff and landing aircraft of claim 1, wherein the airframe further comprises a first aerodynamic control surface configured to generate a yaw moment on the vertical takeoff and landing aircraft, a second aerodynamic control surface configured to generate a pitch moment on the vertical takeoff and landing aircraft, and a third aerodynamic control surface configured to generate a roll moment on the vertical takeoff and landing aircraft.

3. The vertical takeoff and landing aircraft of claim 1, wherein at least one of the relative thrust angles is less than 3 degrees.

4. The vertical takeoff and landing aircraft of claim 1, wherein the plurality of vertical thrust rotors comprises at least six vertical thrust rotors.

5. The vertical takeoff and landing aircraft of claim 1, wherein a combined maximum thrust of the plurality of vertical thrust rotors is greater than 120% of a maximum takeoff weight of the vertical takeoff and landing aircraft.

6. The vertical takeoff and landing aircraft of claim 1, wherein each of the plurality of vertical thrust rotors is driven by a vertical thrust electric motor.

7. The vertical takeoff and landing aircraft of claim 1, wherein the airframe further comprises a vertical stabilizer.

8. The vertical takeoff and landing aircraft of claim 1, wherein the at least one forward thrust rotor further has a forward rotor pitch angle defined between a plane of rotation of the forward thrust rotor and a forward thrust rotor blade chord line at a point midway between the axis of rotation of the forward thrust rotor and a tip of a forward thrust rotor blade.

9. The vertical takeoff and landing aircraft of claim 8, wherein each of the plurality of vertical thrust rotors further has a vertical rotor pitch angle defined between the plane of rotation of the vertical thrust rotor and a vertical thrust rotor chord line at a point midway between an axis of rotation of the vertical thrust rotor and a tip of a vertical thrust rotor blade.

10. The vertical takeoff and landing aircraft of claim 9, wherein the vertical rotor pitch angle is less than the forward rotor pitch angle.

11. The vertical takeoff and landing aircraft of claim 9, wherein the vertical thrust rotor chord line is larger than the forward thrust rotor blade chord line.

12. The vertical takeoff and landing aircraft of claim 9, wherein the vertical thrust rotor blade is thinner than the forward thrust rotor blade.

13. The vertical takeoff and landing aircraft of claim 9, wherein the plurality of vertical thrust rotors have fixed pitch rotors such that the vertical rotor pitch angle is not adjustable during flight.

14. The vertical takeoff and landing aircraft of claim 9, wherein the forward thrust rotor has fixed pitch rotors such that the forward rotor pitch angle is not adjustable during flight.

15. The vertical takeoff and landing aircraft of claim 1, wherein the plurality of vertical thrust rotors comprises at least four vertical thrust rotors.

16. The vertical takeoff and landing aircraft of claim 1, wherein the plurality of vertical thrust rotors comprises an even number of vertical thrust rotors.

17. The vertical takeoff and landing aircraft of claim 1, further comprising a center of thrust where combined thrust of the plurality of the vertical thrust rotors is acting when the plurality of the vertical thrust rotors are delivering substantially identical amounts of thrust.

18. The vertical takeoff and landing aircraft of claim 17, further comprising:
a center of gravity of the vertical takeoff and landing aircraft; and
a center of lift of the wing, wherein the center of gravity is positioned nearer to a front of the vertical takeoff and landing aircraft than the center of lift of the wing and the center of thrust.

19. The vertical takeoff and landing aircraft of claim 18, wherein the center of thrust is nearer to the front of the vertical takeoff and landing aircraft than the center of lift.

20. A vertical takeoff and landing aircraft, comprising:
an airframe comprising a wing having an airfoil, the airfoil having an airfoil chord line and the wing having a wingspan;
at least one forward thrust rotor having:
a horizontal thrust offset angle defined between the airfoil chord line and an axis of rotation of the forward thrust rotor; and
a forward rotor pitch angle defined between a plane of rotation of the forward thrust rotor and a forward thrust rotor blade chord line at a point midway between the axis of rotation of the forward thrust rotor and a tip of a forward thrust rotor blade;
a plurality of vertical thrust rotors, each of the plurality of vertical thrust rotors having:
a vertical thrust offset angle defined between the airfoil chord line and a plane of rotation of the vertical thrust rotor, wherein the vertical thrust offset angle is between 3 degrees and 10 degrees;
a vertical rotor pitch angle defined between the plane of rotation of the vertical thrust rotor and a vertical thrust rotor chord line at a point midway between an axis of rotation of the vertical thrust rotor and a tip of a vertical thrust rotor blade, wherein the vertical rotor pitch angle is less than the forward rotor pitch angle and the plurality of vertical thrust rotors have fixed pitch rotors such that the vertical rotor pitch angle is not adjustable during flight; and
wherein the axis of rotation of the forward thrust rotor and planes of rotation of the plurality of vertical thrust rotors define a plurality of relative thrust angles that are each less than the horizontal thrust offset angle, and
axes of rotation of the plurality of vertical thrust rotors are spaced apart at distances between 25% and 75% of the wingspan.
